(19) United States
(12) Patent Application Publication
(10) Pub. No.: US 2021/0117104 A1
(43) Pub. Date: Apr. 22, 2021

(54) STORAGE CONTROL DEVICE AND COMPUTER-READABLE RECORDING MEDIUM

(71) Applicant: FUJITSU LIMITED, Kawasaki-shi (JP)

(72) Inventor: Takanori Nakao, Kawasaki (JP)

(73) Assignee: FUJITSU LIMITED, Kawasaki-shi (JP)

(21) Appl. No.: 17/016,441

(22) Filed: Sep. 10, 2020

(30) Foreign Application Priority Data
Oct. 16, 2019 (JP) 2019-189672

(51) Int. Cl. G06F 3/06; G06F 11/10; G06F 11/07

(52) U.S. Cl. CPC G06F 3/0616; G06F 3/0619; G06F 3/064; G06F 11/0757; G06F 3/0659; G06F 3/0683; G06F 11/1076; G06F 3/0653

(57) ABSTRACT

A storage control device, includes: a memory; and a processor coupled to the memory and configured to: receive data to be written; divide the data received into a plurality of blocks; for each group to which two or more blocks among the plurality of blocks and one or more correction codes used for correcting some of the two or more blocks belong, distribute and arrange the blocks and the correction codes in a plurality of storage devices; and at predetermined timing according to an operation status of the plurality of storage devices, change at least one of the number of blocks and the number of correction codes made to belong to the group corresponding to the data.

### CROSS-REFERENCE TO RELATED APPLICATION

This application is based upon and claims the benefit of priority of the prior Japanese Patent Application No. 2019-189672, filed on Oct. 16, 2019, the entire contents of which are incorporated herein by reference.

### FIELD

The embodiments discussed herein are related to a storage control device and a computer-readable recording medium.

### BACKGROUND

A storage system that distributes and stores data in a plurality of storage devices such as a hard disk drive (HDD) and a solid-state drive (SSD) has been used. The storage system divides data into a plurality of blocks, and generates a correction code for repairing a block for the plurality of blocks in some cases. For example, in techniques such as redundant arrays of independent disks (RAID) 5 and RAID 6, a set of blocks and parity belonging to a group called a stripe is distributed and stored in a plurality of storage devices. By making it possible to repair a block by the parity, data retention reliability against a failure of the storage device is improved.

Japanese Laid-open Patent Publication No. 2000-259359, Japanese Laid-open Patent Publication No. 2016-95719, and Japanese National Publication of International Patent Application No. 2018-508073 are examples of related art.

### SUMMARY

According to an aspect of the embodiments, a storage control device, includes: a memory; and a processor coupled to the memory and configured to: receive data to be written; divide the data received into a plurality of blocks; for each group to which two or more blocks among the plurality of blocks and one or more correction codes used for correcting some of the two or more blocks belong, distribute and arrange the blocks and the correction codes in a plurality of storage devices; and at predetermined timing according to an operation status of the plurality of storage devices, change at least one of the number of blocks and the number of correction codes made to belong to the group corresponding to the data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a processing example of a storage control device according to a first embodiment;

FIG. 2 is a diagram illustrating an example of a storage system according to a second embodiment;

FIG. 3 is a block diagram illustrating a hardware example of a controller module (CM);

FIG. 4 is a diagram illustrating an example of data shards and parity shards;

FIG. 5 is a diagram illustrating an example of a disk failure rate;

FIG. 6 is a diagram illustrating a functional example of the CM;

FIG. 7 is a diagram illustrating a data storage example;

FIG. 8 is a diagram illustrating an example of an object management table;

FIG. 9 is a diagram illustrating an erasure code (EC) layout change example;

FIG. 10 is a flowchart illustrating an EC layout change control example of the CM; and

FIG. 11 is a diagram illustrating another example of the EC layout change.

### DESCRIPTION OF EMBODIMENTS

For example, there has been proposed a RAID device that uses an extended Galois field (GF) (2ⁿ) to quickly calculate parity after data is stored in a plurality of disks, and that easily repairs disk contents, even when a plurality of the disks fails at the same time.

There has been proposed a parity layout device that combines a plurality of local parity layouts having different numbers of data areas for calculating local parity, to create a new local parity layout. The local parity is parity calculated from not all but a part of a plurality of data. The local parity layout is an arrangement pattern of data and local parity in a storage area.

An active drive storage system has been proposed in which a controller segments received data into a plurality of data chunks, and generates one or more than two parity chunks corresponding to the plurality of data chunks. The proposed controller reorganizes the plurality of data chunks and the one or more than two parity chunks into stripes, and writes to one or more than two of a plurality of active object storage devices.

As the number of correction codes increases with respect to the number of blocks belonging to a group, block repairability with respect to the number of lost blocks increases, but capacity efficiency for data storage is reduced. A data loss risk in a storage device varies with time. For example, a failure rate of a storage device varies with elapse of use time of the storage device.

When the number of correction codes is increased with respect to the number of blocks in case the data loss risk is relatively high, data retention reliability is excessively increased when the data loss risk is relatively low, and the capacity efficiency for data storage may not be sufficiently exhibited. On the other hand, when the number of correction codes with respect to the number of blocks is decreased in consideration of only a case where the data loss risk is relatively low, a possibility that the blocks may not be repaired is increased when the data loss risk is relatively high.

In an aspect according to the present disclosure, a storage control device and a program that make it possible to adjust a degree of data retention reliability may be provided.

Hereinafter, embodiments will be described with reference to the drawings.

### First Embodiment

A first embodiment will be described.

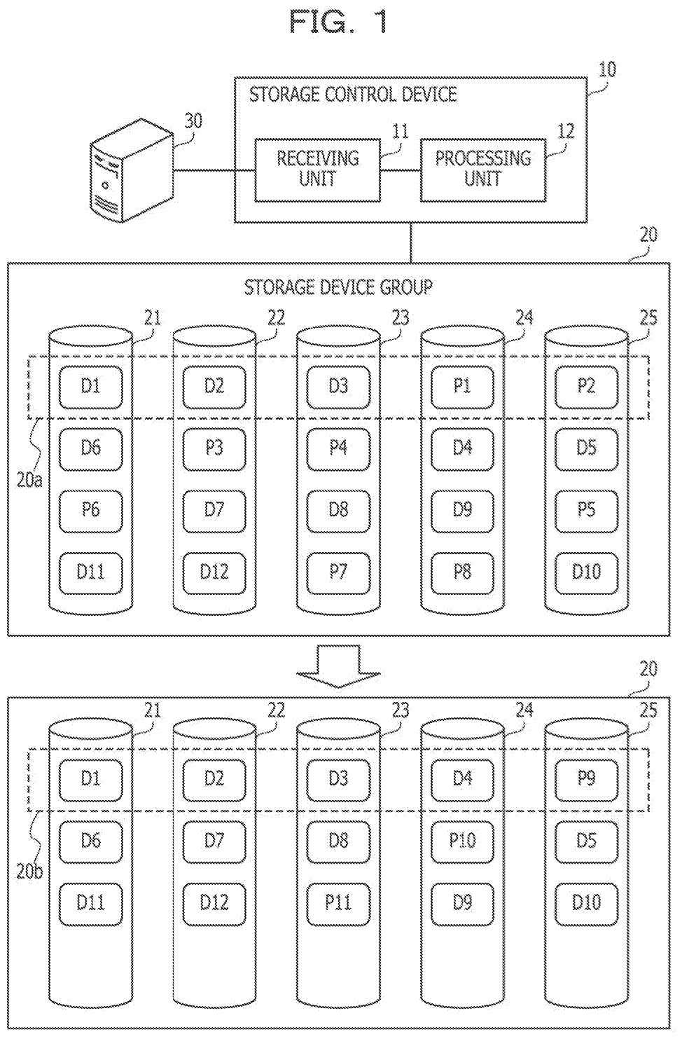

FIG. 1 is a diagram illustrating a processing example of a storage control device according to the first embodiment.

A storage control device 10 is coupled to a storage device group 20 and an information processing device 30. The storage control device 10 receives data to be written from the information processing device 30, and writes the data to a plurality of storage devices belonging to the storage device group 20. For example, the storage device group 20 includes storage devices 21, 22, 23, 24, and 25. Each of the storage devices 21 to 25 is an HDD, an SSD, or the like. The storage control device 10 and the storage device group 20 may be built into one housing. A housing including the storage control device 10 and the storage device group 20 may be referred to as a storage system.

The storage control device 10 includes a receiving unit 11 and a processing unit 12.

The receiving unit 11 is an interface coupled to the information processing device 30. The receiving unit 11 may be directly coupled to the information processing device 30 by a cable, or may be coupled via a network such as a storage area network (SAN) or a local area network (LAN). The receiving unit 11 receives data to be written.

The processing unit 12 may include a central processing unit (CPU), a digital signal processor (DSP), an application-specific integrated circuit (ASIC), a field-programmable gate array (FPGA), or the like. The processing unit 12 may be a processor that executes a program. The “processor” referred to herein may include a set of a plurality of processors (multiprocessor).

The processing unit 12 divides the data received by the receiving unit 11 into a plurality of blocks. A size of one block is predetermined. For example, the processing unit 12 divides the data received into 12 blocks D1 to D12.

The processing unit 12, for each group to which two or more blocks of the plurality of blocks and one or more correction codes used for correction of some of the two or more blocks belong, distributes and arranges the blocks and the correction codes in the plurality of storage devices. The correction code is, for example, an erasure code (EC). The correction code may be an error correcting code (ECC). One group may also be referred to as a stripe.

For example, the processing unit 12 divides the 12 blocks D1 to D12 with three blocks as a group, and generates two correction codes for three blocks. In this case, the processing unit 12 creates four groups. A first group includes the blocks D1 to D3 and correction codes P1 and P2. A second group includes the blocks D4 to D6 and correction codes P3 and P4. A third group includes blocks D7 to D9 and correction codes P5 and P6. A fourth group includes blocks D10 to D12 and correction codes P7 and P8.

For example, the processing unit 12 distributes and arranges the blocks and the correction codes in the storage devices 21, 22, 23, 24, and 25 for each group. In FIG. 1, two examples of the storage device group 20 are illustrated on an upper side and a lower side, respectively. The storage device group 20 on the upper side illustrates an initial layout of the blocks and the correction codes in the storage device group 20. The layout is an arrangement pattern of the blocks and the correction codes for each storage area in the storage device group 20. A group 20a corresponds to the first group described above. For example, in the group 20a, the blocks and the correction codes are arranged in the storage device group 20 as follows. The block D1 is arranged in the storage device 21. The block D2 is arranged in the storage device 22. The block D3 is arranged in the storage device 23. The correction code P1 is arranged in the storage device 24. The correction code P2 is arranged in the storage device 25. The blocks and the correction codes included in each of the second to fourth groups described above are also distributed and arranged in the storage devices 21 to 25.

The processing unit 12, at predetermined timing according to an operation status of the plurality of storage devices, changes at least one of the number of blocks and the number of correction codes made to belong to a group corresponding to data already written in the plurality of storage devices. For example, the processing unit 12 may change at least one of the number of blocks and the number of correction codes made to belong to a group, to change a ratio of the number of correction codes in the group. As a ratio of the number of correction codes in a group increases, failure resistance of a storage device tends to improve. A ratio of the number of correction codes in a group is b/(a+b), that is a ratio of the number of correction codes b to a sum a+b of the number of blocks a and the number of correction codes b belonging to the group.

The timing according to the operation status is determined, for example, based on respective failure rates of the storage devices 21 to 25 with respect to use time of the storage devices 21 to 25. As an example, timing at which a reliability index value of each of the storage devices 21 to 25 falls below a lower threshold value, and timing at which an upper threshold value is exceeded are conceivable. The reliability index value is an index related to a possibility of erasure for data, and for example, is represented by a probability that all data is not lost in a predetermined period such as one year. The reliability index value is calculated by predetermined calculation based on the respective failure rates of the storage devices 21 to 25 according to elapsed time from start of use of the storage devices 21 to 25. The lower threshold value and the upper threshold value of the reliability index value are given in advance. For example, the processing unit 12 periodically calculates and monitors the respective reliability index values for the storage devices 21 to 25. When the reliability index value is smaller than the lower threshold value of a reference range, the processing unit 12 determines that a data loss risk is higher than a reference, and increases the ratio of the number of correction codes in the group. When the reliability index value is larger than the upper threshold value of the reference range, the processing unit 12 determines that the data loss risk is lower than the reference, and decreases the ratio of the number of correction codes in the group.

The storage device group 20 on the lower side of FIG. 1 illustrates an example of a layout after the number of blocks and the number of correction codes belonging to one group are changed. The example in FIG. 1 illustrates a case where the ratio of the number of correction codes is decreased. As described above, the processing unit 12 decreases the ratio of the number of correction codes at timing when it is determined that the data loss risk is relatively low.

Here, the processing unit 12 divides the blocks D1 to D12 with four blocks as a group, and generates one correction code for four blocks.

The group 20b is an example of a group after the layout change. The group 20b includes the blocks D1 to D4 and a correction code P9. After the layout change, the groups before the layout change are reorganized into three groups in total, for example, in addition to the group 20b, a group including the blocks D5 to D8 and a correction code P10, and a group including the blocks D9 to D12 and a correction code P11.

In the example in FIG. 1, before the layout change, the ratio of the number of correction codes in one group is 2/(3+2)=2/5=0.4. Capacity efficiency before the layout change is 1−0.4=0.6. On the other hand, after the layout change, the ratio of the number of correction codes in one group is 1/(4+1)=1/5=0.2. The capacity efficiency after the layout change is 1−0.2=0.8.

The processing unit 12 monitors the operation status of the storage devices 21 to 25 even after the layout change. The processing unit 12, when a situation in which the data loss risk is relatively high is detected again, increases the ratio of the number of correction codes.

According to the storage control device 10, data to be written is divided into a plurality of blocks. For each group including two or more blocks among the plurality of blocks and one or more correction codes used for correction of some of the two or more blocks, the blocks and the correction codes are distributed and arranged in a plurality of storage devices. At predetermined timing according to an operation status of the plurality of storage devices, at least one of the number of blocks and the number of correction codes made to belong to a group corresponding to the data is changed.

This makes it possible to adjust a degree of data retention reliability.

For example, as a ratio of the number of correction codes to a total number of the number of blocks and the number of correction codes belonging to one group increases, a repairability of a lost block often improves.

Before the layout change described above, the two correction codes are held for the three blocks. Thus, for example, when a correction code is an EC, even when up to two blocks are lost simultaneously in a group, the lost blocks may be repaired. On the other hand, after the above layout change, the one correction code is held for the four blocks. Thus, for example, when the correction code is an EC, even when one block is lost in a group, the lost block may be repaired, but when two or more blocks are lost simultaneously, the lost blocks may not be repaired.

Thus, for example, a ratio of the number of correction codes in a group may be associated with a degree of data retention reliability. For example, as a ratio of the number of correction codes increases, a degree of data retention reliability tends to increase, and the ratio of the number of correction codes decreases, the degree of data retention reliability tends to decrease.

On the other hand, as a ratio of the number of correction codes in a group increases, capacity efficiency for data storage decreases. As described above, while the capacity efficiency is 0.6 before the above layout change, the capacity efficiency is improved to 0.8 after the layout change. As described above, as for the ratio of the number of correction codes, the data retention reliability and the capacity efficiency are in a trade-off relationship.

For example, when a data loss risk is relatively high, by prioritizing reliability over capacity efficiency to reduce a data loss possibility, operation of the storage device group 20 may be smoothed. On the other hand, when the data loss risk is relatively low, by prioritizing the capacity efficiency over the reliability, performance of the storage devices 21 to 25 may be sufficiently exhibited.

Thus, the storage control device 10, in accordance with an operation status of the storage devices 21 to 25, changes at least one of the number of blocks and the number of correction codes in a group, to enable adjustment of a degree of data retention reliability. For example, at each timing of operation, by switching, of a mode prioritizing reliability and a mode prioritizing capacity efficiency, to a mode suitable for the timing, operation of the storage device group 20 may be smoothed.

The processing unit 12 may sequentially and cyclically arrange a plurality of blocks obtained by dividing data in a plurality of storage devices. In the example in FIG. 1, it is conceivable that the processing unit 12 sequentially and cyclically arranges the blocks D1 to D12 in the storage devices 21 to 25. For example, the processing unit 12 arranges the blocks D1, D2, D3, D4, D5, D6, and so on, in the storage devices 21, 22, 23, 24, 25, 21, and so on, respectively. For example, for example, the processing unit 12 arranges the blocks D1, D6, and D11 in the storage device 21. The processing unit 12 arranges the blocks D2, D7, and D12 in the storage device 22. The processing unit 12 arranges the blocks D3 and D8 in the storage device 23. The processing unit 12 arranges the blocks D4 and D9 in the storage device 24. The processing unit 12 arranges the blocks D5 and D10 in the storage device 25. The processing unit 12 selects blocks made to belong to each group in an order of arrangement, for example, blocks D1, D2, and so on. In this way, the processing unit 12 is not demanded to move the blocks D1 to D12 among the storage devices between before and after the layout change. It is sufficient that, as for the blocks, the processing unit 12 changes information of correspondence relationships of blocks belonging to a group, and thus a cost of movement processing of the blocks among storage devices may be reduced. Thus, the storage control device 10 may perform a layout change quickly.

### Second Embodiment

Next, a second embodiment will be described.

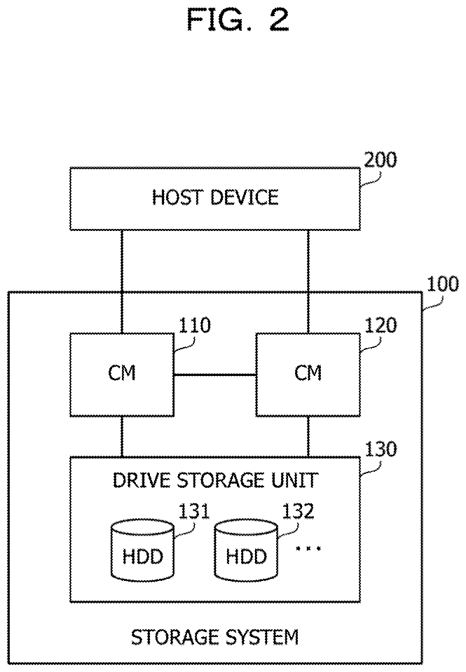

FIG. 2 is a diagram illustrating an example of a storage system according to the second embodiment.

A storage system 100 is coupled to a host device 200. The storage system 100 stores data of a user who uses the host device 200. For example, the storage system 100 may be directly coupled by a cable, or may be coupled via a network such as a SAN or a IAN, to the host device 200.

The storage system 100 includes controller modules (CMs) 110, 120, and a drive storage unit 130.

Each of the CMs 110 and 120 controls access such as writing and reading of data to and from a plurality of storage devices such as HDDs and SSDs stored in the drive storage unit 130. Each of the CMs 110 and 120 receives an access request for writing or reading data from the host device 200, accesses a storage device for writing or reading data in response to the access request, and returns an access result to the host device 200.

The CMs 110 and 120 are made redundant to achieve high availability of data access. For example, when operating normally, the CMs 110 and 120 share access to data. Even when the CM on one side stops, the CM on another side may continue data access. Each of the CMs 110 and 120 is an example of the storage control device 10 according to the first embodiment.

The drive storage unit 130 houses a plurality of storage devices such as HDDs and SSDs, and provides a mass storage area by the plurality of storage devices. For example, the drive storage unit 130 includes HDDs 131, 132, and so on.

The host device 200 executes an application, reads data used for processing of the application from the storage system 100, or writes data used for processing of the application to the storage system 100. The host device 200 is, for example, a server computer. The host device 200 is an example of the information processing device 30 according to the first embodiment.

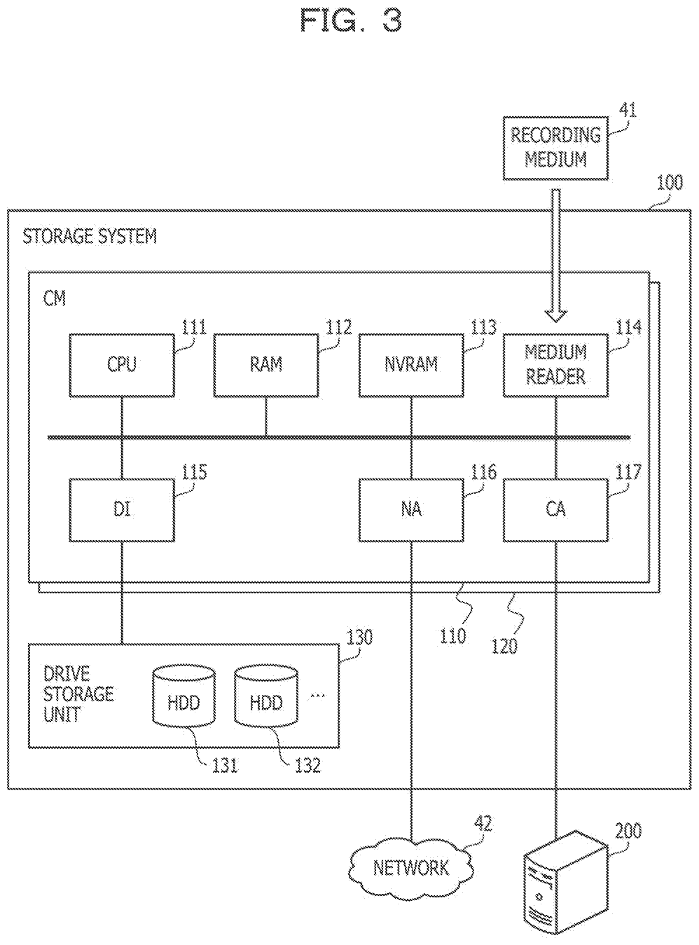

FIG. 3 is a block diagram illustrating a hardware example of the CM.

The CM 110 includes a CPU 111, a random-access memory (RAM) 112, a non-volatile RAM (NVRAM) 113, a medium reader 114, a drive interface (DI) 115, a network adapter (NA) 116, and a channel adapter (CA) 117. These pieces of hardware are coupled to a bus of the CM 110. The CPU 111 is an example of the processing unit 12 according to the first embodiment. The CA 117 is an example of the receiving unit 11 according to the first embodiment.

The CPU 111 is a processor that controls an entirety of the CM 110. The CPU 111 loads at least a part of programs and data for an operating system (OS) and firmware stored in the NVRAM 113 into the RAM 112 and executes the programs.

The RAM 112 is a main storage device of the CM 110. The RAM 112 stores a program executed by the CPU 111 and various data used for processing by the CPU 111.

The NVRAM 113 is an auxiliary storage device of the CM 110. The NVRAM 113 stores a program to be loaded into the RAM 112 and various data used for processing by the CPU 111.

The medium reader 114 is a reading device that reads programs such as an OS and firmware and data recorded in a recording medium 41. As the recording medium 41, for example, a semiconductor memory such as a Universal Serial Bus (USB) flash drive (also referred to as a USB memory) may be used. The recording medium 41 may be referred to as a computer-readable recording medium. For example, the medium reader 114 copies a program or data read from the recording medium 41 into another recording medium such as the RAM 112 or the NVRAM 113. The read program is executed by, for example, the CPU 111.

The recording medium 41 may be a portable recording medium, and may be used to distribute a program or data. Examples of the recording medium 41 used as a portable recording medium include a magnetic disk, an optical disk, a magneto-optical disk (MO), and a semiconductor memory. The magnetic disk includes a flexible disk (FD) or an HDD. The optical disk includes a compact disk (CD) or a digital versatile disk (DVD).

The DI 115 is an interface for accessing the HDDs 131, 132, and so on, stored in the drive storage unit 130.

NA 116 is a communication interface that is coupled to a network 42 and communicates with other server computers via the network 42. For example, the CM 110 may download a program of firmware from another server computer via the network 42, and store the program in the RAM 112, the NVRAM 113, or the recording medium 41.

The CA 117 is a communication interface coupled to the host device 200. For example, Fibre Channel (FC), Internet Small Computer System Interface (iSCSI), Serial Attached SCSI (SAS), and the like are used as standards for a communication interface in the CA 117.

The CM 120 is also realized by similar hardware to that of the CM 110. The CMs 110 and 120 are coupled to each other by an interface for coupling between the CMs, and configured to be redundant. In the storage system 100, even when the CM on one side fails, data access may be continued by the CM on another side.

Although the following description focuses on the CM 110, the CM 120 has similar functions to those of the CM 110.

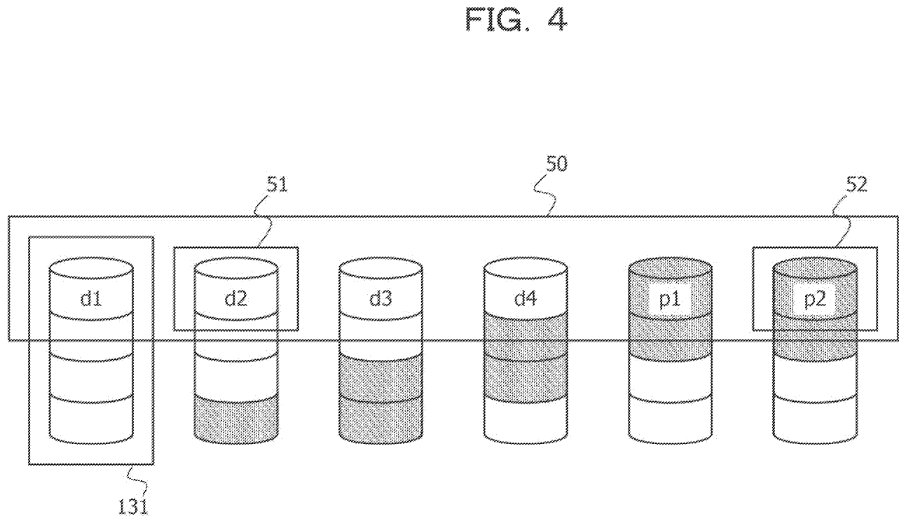

FIG. 4 is a diagram illustrating an example of data shards and parity shards.

The CM 110 divides data to be written received from the host device 200 into a plurality of data shards. The data to be written is called an object. The CM 110 divides the object into a plurality of sub-objects. The CM 110 divides the sub-object into a plurality of data shards.

The CM 110 divides the plurality of data shards with two or more data shards as a set, and generates one or more parity shards by an operation for parity calculation, for each set. A group including the two or more data shards and the one or more parity shards is referred to as a stripe. The data shards and the parity shards are distributed and stored in the HDDs 131, 132, and so on, in units of stripes. Respective sizes of a data shard and a parity shard are predetermined. For example, a size of each of a data shard and a parity shard is 1 megabytes (MB). A data shard corresponds to the block in the first embodiment. A parity shard corresponds to the correction code in the first embodiment. Assume that a parity shard is an erasure code (EC). An arrangement pattern of data shards and parity shards in the HDDs 131, 132, and so on is referred to as an EC layout. A shard is an example of the block in the first embodiment, and may be referred to as a symbol or a chunk. In FIG. 4, a parity shard is indicated by hatching.

For example, a stripe 50 includes data shards d1, d2, d3, and d4 and parity shards p1 and p2. The data shards d1, d2, d3, and d4, and the parity shards p1 and p2 belonging to the stripe 50 being single are stored in different HDDs, respectively. For example, the data shard d is stored in a storage area of the HDD 131. In FIG. 4, the data shard 51 and the parity shard 52 are illustrated so that the data shards and the parity shards belonging to the stripe 50 may be easily understood. The data shard 51 corresponds to data shard d2. The parity shard 52 corresponds to the parity shard p2.

A shard configuration in which the number of data shards is m (m is an integer of 2 or more) and the number of parity shards is n (n is an integer of 1 or more) in a stripe is represented as EC(m+n). The EC layout illustrated in FIG. 4, includes the four data shards and the two parity shards, and thus is represented as EC(4+2).

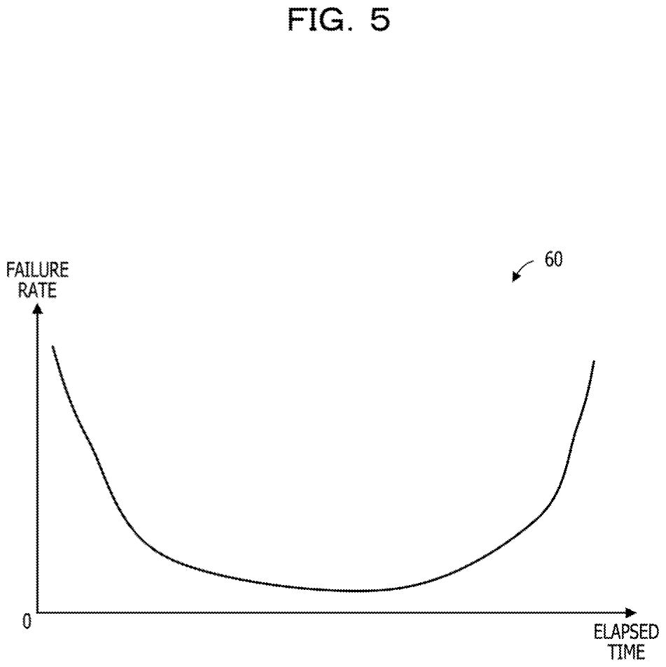

FIG. 5 is a diagram illustrating an example of a disk failure rate.

A graph 60 represents a failure rate of an HDD with respect to elapsed time from the start of use of the HDD. A horizontal axis of the graph 60 indicates the elapsed time from the start of use of the HDD (for example, use time of the HDD). A vertical axis of the graph 60 indicates the failure rate (for example, an annual failure rate) of the HDD. The failure rate of the HDD is high immediately after the start of use, decreases as time elapses, and then increases as time further elapses. The graph 60 may be referred to as a bathtub curve. Information on the bathtub curve is provided in advance by a manufacturer or the like for each product of a storage device. The CM 110 provides a function of changing a ratio of the number of parity shards included in a stripe, based on a relationship between the elapsed time and the failure rate indicated in the graph 60.

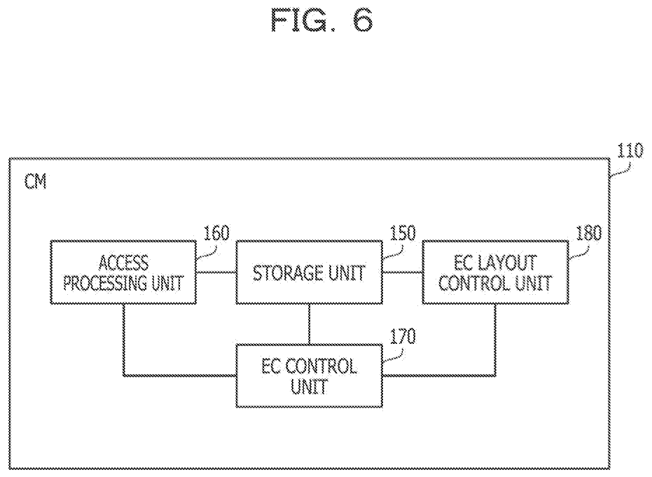

FIG. 6 is a diagram illustrating a functional example of the CM.

The CM 110 includes a storage unit 150, an access processing unit 160, an EC control unit 170, and an EC layout control unit 180. A storage area of the RAM 112 or the NVRAM 113 is used as the storage unit 150. The access processing unit 160, the EC control unit 170, and the EC layout control unit 180 are realized by programs executed by the CPU 111.

The storage unit 150 stores information indicating an EC layout. The information indicating the EC layout includes, for example, a sub-object corresponding to an object, a stripe corresponding to the sub-object, and information on a storage position of a data shard and a storage position of a parity shard corresponding to the stripe.

The storage unit 150 stores an object management table. The object management table holds, for each object, identification information of a storage device allocated for storing a data shard, and identification information of a storage device allocated for storing a parity shard. A storage device group of allocated to an object for storing data shards is referred to as a data group. A storage device group allocated to an object for storing parity shards is referred to as a parity group.

The number of storage devices belonging to a data group and the number of storage devices belonging to a parity group are determined in advance. In one example, the number of storage devices belonging to a data group is six and the number of storage devices belonging to a parity group is three. The number of storage devices belonging to a data group corresponds to an upper limit of the number of data shards per stripe. The number of storage devices belonging to a parity group corresponds to an upper limit of the number of parity shards per stripe.

The access processing unit 160, based on information indicating an EC layout and an object management table stored in the storage unit 150, processes an access request received from the host device 200. The access request is an object write request or an object read request. When writing a new object, the access processing unit 160 generates data shards and parity shards, in accordance with the number of data shards and the number of parity shards indicated by information indicating an EC layout, and distributes and arranges the data shards and the parity shards in the HDDs 131, 132, and so on. At this time, the access processing unit 160 determines HDDs to assign to a data group and HDDs to assign to a parity group for the corresponding object, and records the determined HDDs in the object management table. For example, the access processing unit 160 randomly determines HDDs to assign to the data group and HDDs to assign to the parity group for the corresponding object. The access processing unit 160 writes the data shards to the HDDs belonging to the data group and writes the parity shards to the HDDs belonging to the parity group.

The access processing unit 160 may receive a notification of an EC layout change from the EC control unit 170. Then, the access processing unit 160, based on information indicating a changed EC layout, processes an access request received from the host device 200.

The EC control unit 170 detects a failure in the HDDs 131, 132, and so on, and based on information indicating an EC layout stored in the storage unit 150, repairs an erased data shard due to the failure. For example, when a failed HDD is replaced with a new HDD, the EC control unit 170 performs rebuild processing for repairing a data shard or a parity shard in units of stripes. The EC control unit 170 may receive a notification of an EC layout change from the EC layout control unit 180. When the EC layout is changed, the EC control unit 170 notifies the access processing unit 160 of the EC layout change.

The EC layout control unit 180 performs the EC layout change. For example, the EC layout control unit 180 monitors an operation state of the HDDs 131, 132, and so on, and changes a ratio of the number of parity shards in a stripe according to a monitoring result. The EC layout control unit 180 may change at least one of the number of data shards and the number of parity shards made to belong to a stripe, to change a ratio of the number of parity shards. The EC layout control unit 180 updates information indicating an EC layout stored in the storage unit 150 according to the EC layout change. When changing an EC layout, the EC layout control unit 180 may, based on an object management table stored in the storage unit 150, identify data groups and parity groups for each object. After changing the EC layout, the EC layout control unit 180 notifies the EC control unit 170 of the EC layout change, and causes the EC control unit 170 to recognize the changed EC layout.

As modification examples of the EC layout according to the monitoring of the operation state by the EC layout control unit 180, the following first to fifth examples are conceivable.

In the first example, the EC layout control unit 180, based on the relationship between the elapsed time from the start of use of the HDD and the failure rate illustrated in FIG. 5, estimates timing to change an EC layout. For example, as illustrated in the first embodiment, the EC layout control unit 180 determines whether or not to change an EC layout according to comparison between a reliability index value R calculated from a failure rate and a threshold value. The reliability index value R is represented by, for example, a probability that all data is not lost in one year. For example, the reliability index value R is obtained by the following equation (1).

R=1−AFR*N*((AFR*MTBR*N)\hat{ }M (1)

AFR is an annual failure rate (AFR) of a storage device. AFR is given in advance, based on the relationship between the elapsed time and the failure rate illustrated in FIG. 5.

A mean time between repairs (MTBR) is average recovery time of a storage device (in units of years). Increasing or decreasing the number of data shards in a stripe changes MTBR. As the number of data shards increases, MTBR increases, and as the number of data shards decreases, MTBR decreases. MTBR for the number of data shards is given in advance.

N is the number of storage devices.

M is the number of failed storage devices that may be tolerated. For example, M indicates that when the number of storage devices that fail at the same time is not more than M, erased data shards may be repaired. M changes as the number of parity shards in a stripe increases or decreases. As the number of parity shards increases, M increases, and as the number of parity shards decreases, M decreases.

By calculating 1−{(probability that any storage device fails)*(probability that, before a failed storage device is recovered, M storage devices fail)} according to the equation (1), a probability R that all data is not lost in one year is approximately obtained. The EC layout control unit 180 sets the probability R as the reliability index value R. As a threshold value for the reliability index value R, a value according to a predetermined reference value is used. For example, the reference value is 99.999999999% (eleven nines). The EC layout control unit 180 adjusts a ratio of the number of parity shards, so that the reliability index value R may substantially satisfy the reference value within a reference range.

For example, the EC layout control unit 180 sets a value 99.99999999% (ten nines), that is one-tenth of the reference value, as a lower threshold value of the reference range of the reliability index value R. The appropriate range is referred to as the reference range. The EC layout control unit 180 sets a value 99.9999999999% (twelve nines), that is ten times the reference value, as an upper threshold value of the reference range of the reliability index value R. For example, when the reliability index value R is smaller than the lower threshold value, the EC layout control unit 180 may increase a ratio of the number of parity shards in a stripe, to adjust the reliability index value R to fall within the reference range. When the reliability index value R is larger than the upper threshold value, the EC layout control unit 180 may reduce a ratio of the number of parity shards in a stripe, to adjust the reliability index value R to fall within the reference range.

In the second example, the EC layout control unit 180, depending on elapsed time from the start of use of the HDDs 131, 132, and so on, changes an EC layout at timing when a failure rate of the HDDs 131, 132, and so on, falls below a predetermined threshold value or at timing a predetermined threshold value is exceeded. For example, the EC layout control unit 180, at timing when the failure rate of the HDDs 131, 132, and so on, falls below the predetermined threshold value, reduces a ratio of the number of parity shards in a stripe. Further, the EC layout control unit 180, at timing when the failure rate of the HDDs 131, 132, and so on, exceeds the predetermined threshold value, increases a ratio of the number of parity shards in a stripe.

In the third example, the EC layout control unit 180, at timing when an average sector failure rate in the HDDs 131, 132, and so on, exceeds a predetermined threshold value, increases a ratio of the number of parity shards in a stripe. This is because when the average sector failure rate exceeds the predetermined threshold value, it is estimated that a data loss risk is increased.

In the fourth example, the EC layout control unit 180, at timing when the number of access requests per unit time to the HDDs 131, 132, and so on, falls below a predetermined threshold value, decreases a ratio of the number of parity shards in a stripe. This is because, in a situation where an access request frequency is relatively low, a possibility of a failure of the HDDs 131, 132, and so on, tends to be relatively low.

In the fifth example, the EC layout control unit 180, at timing when, after maintenance of an entirety of the storage system 100 is performed multiple times, and the number of maintenance times in a unit time period falls below a predetermined number of times, decreases a ratio of the number of parity shards in a stripe. This is because, when a frequency of maintenance in a unit time period is relatively low, it is estimated that operation of the storage system 100 enters a stable period, and a possibility of a failure of the HDDs 131, 132, and so on, is relatively low.

The EC layout control unit 180 may use at least two of the above first to fifth examples in combination. For example, the EC layout control unit 180 may perform an EC layout change with satisfaction of any of the determination conditions described in the above first to fifth examples as a bigger.

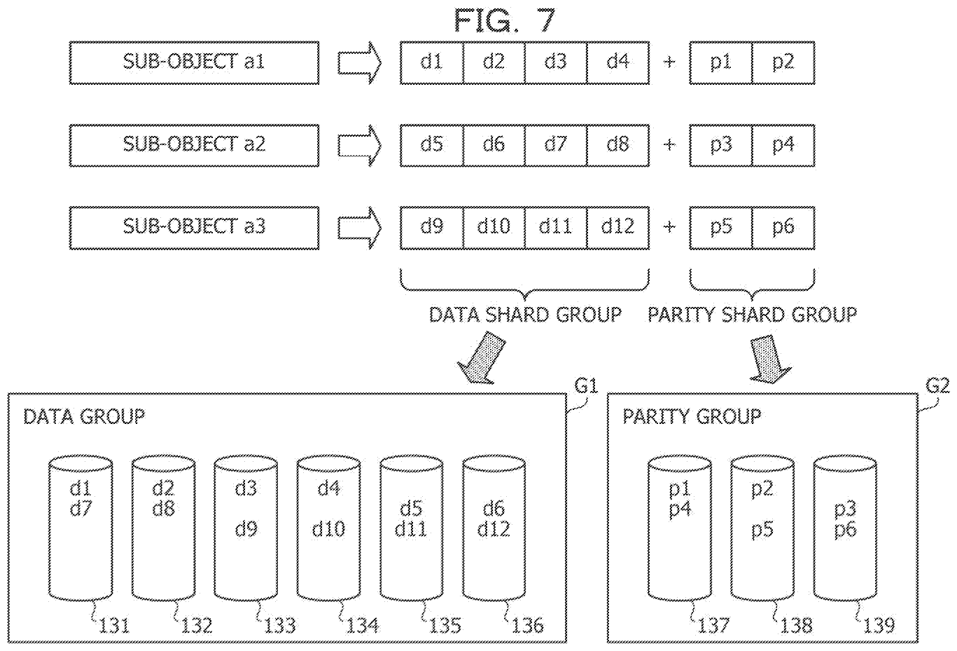

FIG. 7 is a diagram illustrating a data storage example.

The access processing unit 160 receives an object to be written from the host device 200. A data group G1 for the object is a set of the HDDs 131 to 136. A parity group G2 for the object is a set of the HDDs 137 to 139.

The access processing unit 160 divides the object received into sub-objects a1, a2, and a3. An object may be divided into two, or four or more sub-objects. The access processing unit 160 arranges the sub-objects a1, a2, and a3 in the HDDs 131 to 139 using a shard configuration of EC(4+2).

For example, the access processing unit 160 divides the sub-object a1 into data shards d1, d2, d3, and d4. The access processing unit 160 generates parity shards p1 and p2, based on the data shards d1, d2, d3, and d4. The access processing unit 160 arranges the data shards d1, d2, d3, and d4 in the HDD 131, 132, 133, and 134, respectively. The access processing unit 160 arranges the parity shards p1 and p2 in the HDD 137 and 138, respectively.

The access processing unit 160 divides the sub-object a2 into data shards d5, d6, d7, and d8. The access processing unit 160 generates parity shards p3 and p4, based on the data shards d5, d6, d7, and d8. The access processing unit 160 arranges the data shards d5, d6, d7, and d8 in the HDD 135, 136, 131, 132, respectively. The access processing unit 160 arranges the parity shards p3 and p4 in the HDD 139 and 137, respectively.

Further, the access processing unit 160 divides the sub-object a3 into data shards d9, d10, d1l, and d12. The access processing unit 160 generates parity shards p5 and p6, based on the data shards d9, d10, d1l, and d12. The access processing unit 160 arranges the data shards d9, d10, d11, and d12 in the HDD 133, 134, 135, and 136, respectively. The access processing unit 160 arranges the parity shards p5 and p6 in the HDD 138 and 139, respectively.

In this manner, the access processing unit 160 arranges a data shard group in the HDDs 131 to 136 belonging to the data group G1, and arranges a parity shard group in the HDDs 137 to 139 belonging to the parity group G2. At this time, as illustrated in FIG. 7, the access processing unit 160 sequentially and cyclically arranges the data shards d1 to d12 in the HDDs 131 to 136. The access processing unit 160 sequentially and cyclically arranges the parity shards p1 to p6 in the HDDs 137 to 139.

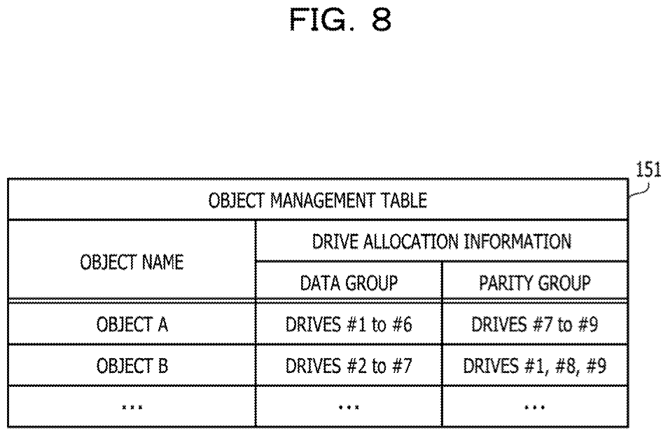

FIG. 8 is a diagram illustrating an example of the object management table.

An object management table 151 is stored in the storage unit 150. The object management table 151 includes items of object names and drive allocation information.

With the item of object name, an object name for identifying an object is registered. With the item of drive allocation information, identification information of drives (here, HDDs) belonging to a data group for the corresponding object, and identification information of drives belonging to a parity group are registered. The drive corresponds to a storage device.

For example, in the object management table 151, a record in which an object name is “object A”, a data group is “drives #1 to #6”, and a parity group is “drives #7 to #9” is registered. This record indicates that the data group for the object identified by the object name “object A” includes six HDDs identified by the identification information of “drives #1 to #6”. The record indicates that the parity group for the object includes three HDDs identified by the identification information of “drives #7 to #9”.

With the object management table 151, drive allocation information is also registered for other objects. An object and another object may have respective HDDs different from each other allocated as a data group and a parity group.

The access processing unit 160 updates the object management table 151 to allocate HDDs of a data group and HDDs of a parity group to each object. The access processing unit 160 allocates, a first HDD group as a storage destination of data shards, and a second HDD group as a storage destination of parity shards, among the HDDs 131, 132, and so on, to a first object. The access processing unit 160 allocates, a third HDD group different from the first HDD group as a storage destination of data shards, and a fourth HDD group different from the second HDD group as a storage destination of the parity shard, among the HDDs 131, 132, and so on, to a second object. This suppresses that only some HDDs are used in a biased manner.

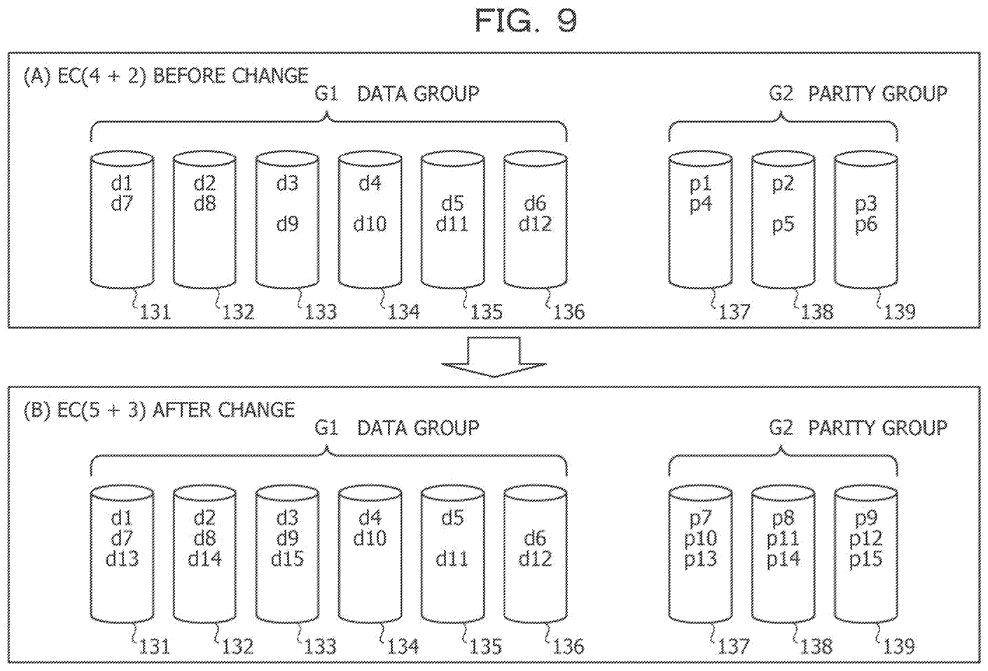

FIG. 9 is a diagram illustrating an EC layout change example.

(A) of FIG. 9 illustrates the state before an EC layout change for a certain object illustrated in FIG. 7. In (A) of FIG. 9, a stripe for data shards d13, d14, d15, and d16, and so on, for the corresponding object is not illustrated. The shard configuration before the EC layout change is EC(4+2).

(B) of FIG. 9 illustrates a state after the EC layout change for the object. As an example, a shard configuration after the EC layout change is EC(5+3).

The EC layout control unit 180 reorganizes the respective stripes in (A) of FIG. 9 as follows.

The EC layout control unit 180 divides the data shards d1, d2, and so on, with five data shards as a group. The EC layout control unit 180, based on the data shards d1 to d5, generates parity shards p7, p8, and p9. The EC layout control unit 180 arranges the parity shards p7, p8, and p9 in the HDD 137, 138, and 139, respectively.

The EC layout control unit 180, based on the data shards d6 to d10, generates parity shards p10, p11, and p12. The EC layout control unit 180 arranges the parity shards p10, p11, and p12 in the HDD 137, 138, and 139, respectively.

The EC layout control unit 180, based on the data shards d11, d12, d13, d14, and d15, generates parity shards p13, p14, and p15. The EC layout control unit 180 arranges the parity shards p13, p14, and p15 in the HDD 137, 138, and 139, respectively.

The EC layout control unit 180, similarly for data shards after data shard d16, generates three parity shards for every five data shards, and arranges the data shards in HDDs of the data group, and the parity shards in HDDs of the parity group. When a remainder occurs in data shards, the EC layout control unit 180 compensates for missing data shards by zero filling (zero padding) or the like.

Since respective sizes of a data shard and a parity shard are fixed, a size of a sub-object formed of data shards included in one stripe is variable.

The data shards d1, d2, and so on, are sequentially and cyclically arranged in the HDDs 131 to 136. The EC layout control unit 180 selects data shards made to belong to each stripe in an order of the data shards d1, d2, and so on (arrangement order). In this way, it is sufficient that the EC layout control unit 180 changes management information indicating a correspondence relationship between stripes and data shards included in information indicating an EC layout in the above EC layout change, and the data shards are not demanded to be moved between HDDs.

Next, a procedure for an EC layout change by the CM 110 will be described.

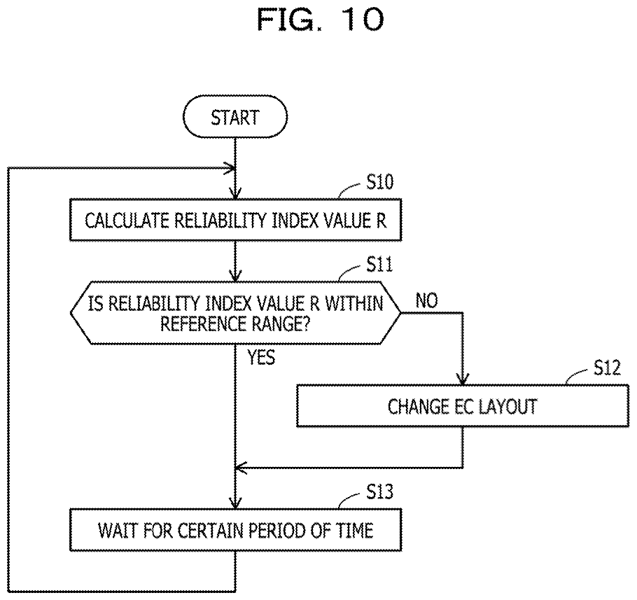

FIG. 10 is a flowchart illustrating an EC layout change control example of a CM.

(S10) The EC layout control unit 180 monitors an operation status of the HDDs 131, 132, and so on, and calculates the reliability index value R according to the operation status. The reliability index value R is calculated according to the above-described equation (1) by using, for example, a failure rate according to elapsed time from the start of use of the HDDs 131, 132, and so on, the number of data shards, and the number of parity shards of the moment.

(S11) The EC layout control unit 180 determines whether or not the reliability index value R falls within a reference range. When the reliability index value R does not fall within the reference range, the processing proceeds to step S12. When the reliability index value R falls within the reference range, the processing proceeds to step S13.

(S12) The EC layout control unit 180 changes an EC layout. For example, when the reliability index value R is smaller than a lower threshold value of the reference range, the EC layout control unit 180 increases a ratio of the number of parity shards in a stripe and causes the reliability index value R to fall within the reference range. When the reliability index value R is larger than an upper threshold value of the reference range, the EC layout control unit 180 decreases a ratio of the number of parity shards in a stripe and causes the reliability index value R to fall within the reference range. For example, the EC layout control unit 180 may calculate in advance reliability index value information indicating the reliability index value R according to a failure rate and a combination of the number of selectable data shards and the number of selectable parity shards, and store the reliability index value information in the storage unit 150. In this case, the EC layout control unit 180, based on the reliability index value information stored in the storage unit 150, selects the number of data shards and the number of parity shards after the change that cause the reliability index value R to fall within a reference range, with respect to a current failure rate.

(S13) The EC layout control unit 180 waits for a predetermined period. For example, a waiting period such as one week or two weeks is predetermined by a user. The processing proceeds to step S10.

In this manner, the EC layout control unit 180 periodically performs the EC layout change control.

The determination criteria illustrated in step S11 are examples, and for example, any of the second to fifth examples illustrated in the description for FIG. 6 may be used. The EC layout control unit 180, instead of or in combination with the determination criterion in step S11, based on at least one of the number of defective storage areas in the HDDs 131, 132, and so on, a frequency of access requests to the HDDs 131, 132, and so on, and a frequency of maintenance performed for the HDDs 131, 132, and so on, may determine timing of an EC layout change. For example, in step S11, the EC layout control unit 180 may change an EC layout, when any of the determination conditions described in the first to fifth examples is satisfied.

Since the HDDs 131, 132, and so on, used are often of the same type, it may be considered that each of the HDDs follows the same bathtub curve. One of the HDDs 131, 132, and so on, may be replaced due to a failure. In this case, for example, it is conceivable that, as AFR used in the equation (1), an average value of failure rates for the respective HDDs is used.

The EC layout control unit 180, according to elapsed time from the start of use of the HDDs 131, 132, and so on, may change an EC layout in stages. For example, since a failure rate of an HDD is relatively high immediately after the start of use, the EC layout control unit 180 sets an EC layout to EC(4+3), and then changes the EC layout to EC(10+2) when operation becomes stable. Since the failure rate gradually increases thereafter, the EC layout control unit 180 may change the EC layout in stages to EC(8+2), EC(8+3), and EC(4+3), for example.

In this way, the CM 110 makes it possible to adjust a degree of data retention reliability in accordance with an operation status of the HDDs 131, 132, and so on.

In step S12, reorganization of stripes along with an EC layout change is performed for each object. Respective data shards related to an object are sequentially and cyclically arranged in each of the HDDs belonging to a data group of the object. Thus, in the EC layout change in step S12, it is sufficient that the EC layout control unit 180 changes the management information indicating the correspondence relationship between the stripes and the data shards in the information indicating the EC layout, and the data shard are not demanded to be moved between the HDDs. For example, the CM 110 sequentially and cyclically arranges the respective data shards in each of the HDDs, and allocates the data shard to the stripe in the arrangement order, thereby changing the number of data shards made to belong to the stripe, without moving the data shards among the HDDs.

On the other hand, it is conceivable that the EC layout control unit 180 changes an EC layout involving movement of data shards as described below.

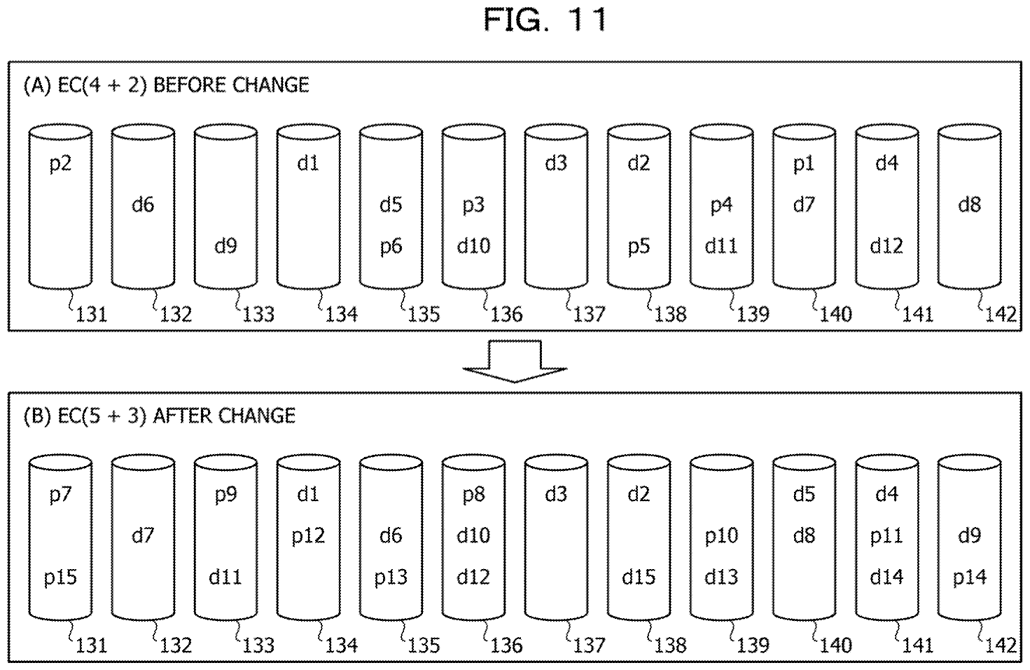

FIG. 11 is a diagram illustrating another example of the EC layout change.

(A) of FIG. 11 illustrates an example of an EC layout before a change in which data shards and parity shards are stored in the HDDs 131 to 142 using EC(4+2). (A) of FIG. 11 illustrates a stripe including the data shards d1 to d4 and the parity shards p1 and p2, a stripe including the data shards d5 to d8 and the parity shards p3 and p4, and a stripe including the data shards d9 to d12 and the parity shards p5 and p6. In the example of FIG. 11, the HDDs that are storage destinations for the data shards and the parity shards of each stripe are randomly determined by the access processing unit 160.

(B) of FIG. 11 illustrates an EC layout after changing the EC layout in (A) of FIG. 11 to EC(5+3). (B) of FIG. 11 illustrates a stripe including the data shards d1 to d5 and the parity shards p7 to p9, a stripe including the data shards d6 to d10 and the parity shards p10 to p12, and a stripe including the data shards d11 to d15, and the parity shards p13 to p15.

For example, when an EC layout is changed, the CM 110 may randomly determine HDDs that are storage destinations of data shard and parity shard for each stripe after the change. However, in this case, movement of the data shards occurs along with the EC layout change. In the example in FIG. 11, the data shard d5 is moved from the HDD 135 to the HDD 140. The data shard d6 is moved from the HDD 132 to the HDD 135. Other data shards may also be moved from one HDD to another. The movement of the data shards along with the EC layout change may cause delay in completion of a change process.

Thus, as described above, it is preferable that respective data shards related to an object be sequentially and cyclically arranged in HDDs. In this way, it is sufficient that the EC layout control unit 180 changes management information indicating a correspondence relationship between the stripes and the data shards in the information indicating the EC layout at the EC layout change, and the data shards are not demanded to be moved between the HDDs. Thus, the EC layout change may be performed at high speed. For example, compared to the method of moving the data shards illustrated in FIG. 11, the EC layout may be changed only by rewriting the parity shards. The speed-up effect is enhanced when there are many data shards. For example, when an EC layout is changed from EC(4+2) to EC(6+2), the change may be performed about four times faster, compared to the method in which data shards are moved. When an EC layout is changed from EC(4+2) to EC(10+2), the change may be performed about six times faster, compared to the method in which data shards are moved.

Furthermore, providing an HDD group for storing data shards (data group) and an HDD group for storing parity shards (parity group) for each object, suppresses storage of data shards or parity shards in one HDD in a biased manner. Thus, usage rates of the respective HDDs may be equalized. As the number of stored objects is increased, the equalization of the usage rates of the respective HDD is promoted.

The information processing in the first embodiment may be realized by causing the processing unit 12 to execute programs. The information processing in the second embodiment may be realized by causing the CPU 111 to execute programs. The program may be recorded in the computer-readable recording medium 41.

For example, a program may be circulated by distributing the recording medium 41 in which the program is recorded. A program may be stored in another computer, and the program may be distributed through a network. For example, a computer may store (install) a program recorded in the recording medium 41 or a program received from another computer in a storage device such as the RAM 112 or the NVRAM 113, read the program from the storage device, and execute the program.

With respect to embodiments including the first and second embodiments, the following claims are further disclosed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control device, comprising:
a memory; and
a processor coupled to the memory and configured to:
receive data to be written; and
divide the data received into a plurality of blocks;
for each group to which two or more blocks among the plurality of blocks and one or more correction codes used for correcting some of the two or more blocks belong, distribute and arrange the blocks and the correction codes in a plurality of storage devices; and
at predetermined timing according to an operation status of the plurality of storage devices, change at least one of the number of blocks and the number of correction codes made to belong to the group corresponding to the data.

2. The storage control device according to claim 1, wherein
the processor determines the timing based on a failure rate according to use time of a storage device.

3. The storage control device according to claim 2, wherein
the processor calculates a reliability index value relating to a possibility of erasure for the data based on the failure rate, and determines the timing in accordance with comparison between the reliability index value and a predetermined threshold value.

4. The storage control device according to claim 3, wherein
the processor increases a ratio of the number of the correction codes in the group when the reliability index value is smaller than a lower threshold value of a reference range, and decreases a ratio of the number of correction codes in the group when the reliability index value is larger than an upper threshold value of the reference range.

5. The storage control device according to claim 1, wherein
the processor determines the timing, based on at least one of the number of defective storage areas in the plurality of storage devices, a frequency of access requests for the plurality of storage devices, and a frequency of maintenance performed for the plurality of storage devices.

6. The storage control device according to claim 1, wherein
the processor sequentially and cyclically arranges the plurality of blocks in the plurality of storage devices, and allocates the blocks to the group in an arrangement order, to change the number of blocks made to belong to the group, without moving the blocks among the plurality of storage devices.

7. The storage control device according to claim 6, wherein
the processor
assigns, among the plurality of storage devices, a first storage device group as a storage destination of the blocks, and a second storage device group as a storage destination of the correction codes, to first data, and
assigns, among the plurality of storage devices, a third storage device group different from a first storage device group as a storage destination of the blocks, and a fourth storage device group different from the second storage device group as a storage destination of the correction codes, to second data.

8. A non-transitory computer-readable recording medium having stored therein a program for causing a computer to execute processing comprising:
dividing data to be written into a plurality of blocks, for each group to which two or more blocks in the plurality of blocks and one or more correction codes used for correcting some of the two or more blocks, to distribute and arrange the blocks and the correction codes in a plurality of storage devices; and
changing at least one of the number of blocks and the number of correction codes made to belong to the group corresponding to the data, at predetermined timing in accordance with an operation status of the plurality of storage devices.

9. The non-transitory computer-readable recording medium according to claim 8, further comprising:
determining the timing based on a failure rate in accordance with use time of a storage device.

10. The non-transitory computer-readable recording medium according to claim 9, further comprising:
calculating a reliability index value related to a possibility of erasure for the data based on the failure rate, and determining the timing in accordance with comparison between the reliability index value and a predetermined threshold value.

11. The non-transitory computer-readable recording medium according to claim 10, further comprising:
increasing a ratio of the number of correction codes in the group when the reliability index value is smaller than a lower threshold value of a reference range, and decreasing a ratio of the number of correction codes in the group when the reliability index value is larger than an upper threshold value of the reference range.

12. The non-transitory computer-readable recording medium according to claim 8, further comprising:
determining the timing based on at least any one of the number of defective storage areas in the plurality of storage devices, a frequency of access requests for the plurality of storage devices, and a frequency of maintenance performed for the plurality of storage devices.

13. The non-transitory computer-readable recording medium according to claim 8, further comprising:
sequentially and cyclically arranging the plurality of blocks in the plurality of storage devices, and assigning the blocks to the groups in an arrangement order, to change the number of blocks made to belong to the group, without moving the blocks among the plurality of storage devices.

14. The non-transitory computer-readable recording medium according to claim 13, further comprising:
assigning, among the plurality of storage devices, a first storage device group as a storage destination of the blocks, and a second storage device group as a storage destination of the correction codes, to first data; and
assigning, among the plurality of storage devices, a third storage device group different from a first storage device group as a storage destination of the blocks, and a fourth storage device group different from the second storage device group as a storage destination of the correction codes, to second data.
